(19) United States
(12) Patent Application Publication
(10) Pub. No.: US 2020/0280065 A1
(43) Pub. Date: Sep. 3, 2020

(54) Positive Electrode Active Material for Lithium Secondary Battery, Method of Preparing the Same, and Positive Electrode for Lithium Secondary Battery and Lithium Secondary Battery which Include the Positive Electrode Active Material

(71) Applicant: LG Chem, Ltd., Seoul (KR)

(72) Inventors: Wook Jang, Daejeon (KR); Hong Kyu Park, Daejeon (KR); Hyo Joung Nam, Daejeon (KR); Seong Bae Kim, Daejeon (KR); Dong Jin Kim, Daejeon (KR)

(73) Assignee: LG Chem, Ltd., Seoul (KR)

(21) Appl. No.: 16/646,212

(22) PCT Filed: Dec. 5, 2018
(86) PCT No.: PCT/KR2018/015331

§ 371 Date: Mar. 11, 2020

(30) Foreign Application Priority Data
Dec. 11, 2017 (KR) 10-2017-0169449

(51) Int. Cl. H01M 4/505; H01M 4/36; H01M 4/525; H01M 4/131; H01M 10/0525; C01G 53/00

(52) U.S. Cl. CPC H01M 4/505; H01M 4/366; H01M 4/525; H01M 2004/028; H01M 10/0525; C01G 53/50; H01M 4/131

(57) ABSTRACT

A positive electrode active material includes a lithium transition metal oxide represented by Formula 1, wherein the lithium transition metal oxide includes a center portion having a layered structure and a surface portion having a secondary phase with a structure different from that of the center portion.

Li_{1±a}(NiₓCo_{y}M¹_{z}M²_{w})₁₋ₐO₂ [Formula 1]

In Formula 1,
0≤a≤0.2, 0.6≤x≤1, 0≤y≤0.4, 0≤z≤0.4, and 0≤w≤0.1,
M¹ includes at least one selected from the group consisting of manganese (Mn) and aluminum (Al), and
M² includes at least one selected from the group consisting of zirconium (Zr), boron (B), tungsten (W), molybdenum (Mo), chromium (Cr), tantalum (Ta), niobium (Nb), magnesium (Mg), cerium (Ce), hafnium (Hf), lanthanum (La), titanium (Ti), strontium (Sr), barium (Ba), fluorine (F), phosphorus (P), sulfur (S), and yttrium (Y). A method of preparing the positive active material is also provided.

### TECHNICAL FIELD

### Cross-Reference to Related Applications

This application claims the benefit of Korean Patent Application No. 2017-0169449, filed on Dec. 11, 2017, in the Korean Intellectual Property Office, the disclosure of which is incorporated herein in its entirety by reference.

### TECHNICAL FIELD

The present invention relates to a positive electrode active material for a lithium secondary battery, a method of preparing the positive electrode active material, and a positive electrode for a lithium secondary battery and a lithium secondary battery which include the positive electrode active material.

### BACKGROUND ART

Demand for secondary batteries as an energy source has been significantly increased as technology development and demand with respect to mobile devices have increased. Among these secondary batteries, lithium secondary batteries having high energy density, high voltage, long cycle life, and low self-discharging rate have been commercialized and widely used.

Lithium transition metal composite oxides have been used as a positive electrode active material of the lithium secondary battery, and, among these oxides, a lithium cobalt composite metal oxide, such as LiCoO₂, having a high operating voltage and excellent capacity characteristics has been mainly used. However, the LiCoO₂ has very poor thermal properties due to an unstable crystal structure caused by delithiation. Also, since the LiCoO₂ is expensive, there is a limitation in using a large amount of the LiCoO₂ as a power source for applications such as electric vehicles.

Lithium manganese composite metal oxides (LiMnO₂ or LiMn₂O₄), lithium iron phosphate compounds (LiFePO₄, etc.), or lithium nickel composite metal oxides (LiNiO₂, etc.) have been developed as materials for replacing the LiCoO₂. Among these materials, research and development of the lithium nickel composite metal oxides, in which a large capacity battery may be easily achieved due to a high reversible capacity of about 200 mAh/g, have been more actively conducted. However, the LiNiO₂ has limitations in that the LiNiO₂ has poorer thermal stability than the LiCoO₂ and, when an internal short circuit occurs in a charged state due to an external pressure, the positive electrode active material itself is decomposed to cause rupture and ignition of the battery. Accordingly, as a method to improve low thermal stability while maintaining the excellent reversible capacity of the LiNiO₂, a lithium nickel cobalt manganese oxide, in which a portion of nickel (Ni) is substituted with cobalt (Co), manganese (Mn), or aluminum (Al), has been developed.

However, with respect to the lithium nickel cobalt manganese oxide, structural stability and capacity are low, and there is a limitation in that the stability is further reduced particularly when the amount of nickel is increased to increase capacity characteristics.

Thus, in a positive electrode active material including a high nickel content which exhibits high capacity characteristics, there is a need to develop a positive electrode active material capable of preparing a high-capacity and long-life battery due to excellent stability of the positive electrode active material.

### DISCLOSURE OF THE INVENTION

### Technical Problem

An aspect of the present invention provides a positive electrode active material having improved structural stability.

Another aspect of the present invention provides a method of preparing the positive electrode active material.

Another aspect of the present invention provides a positive electrode for a lithium secondary battery which includes the positive electrode active material.

Another aspect of the present invention provides a lithium secondary battery including the positive electrode for a lithium secondary battery.

### Technical Solution

According to an aspect of the present invention, there is provided a positive electrode active material including a lithium transition metal oxide represented by Formula 1, wherein the lithium transition metal oxide includes a center portion having a layered structure and a surface portion having a secondary phase with a structure different from that of the center portion.

Li₁₊ₐ(NiₓCo_{y}M¹_{z}M²_{w})₁₋ₐO₂ [Formula 1]

In Formula 1,

0≤a≤0.2, 0.6≤x≤1, 0≤y≤0.4, 0≤z≤0.4, M¹ includes at least one selected from the group consisting of manganese (Mn) and aluminum (Al), and M² includes at least one selected from the group consisting of zirconium (Zr), boron (B), tungsten (W), molybdenum (Mo), chromium (Cr), tantalum (Ta), niobium (Nb), magnesium (Mg), cerium (Ce), hafnium (Hf), lanthanum (La), titanium (Ti), strontium (Sr), barium (Ba), fluorine (F), phosphorus (P), sulfur (S), and yttrium (Y).

According to another aspect of the present invention, there is provided a method of preparing a positive electrode active material which includes: mixing a positive electrode active material precursor with a lithium raw material and performing a primary heat treatment; and performing a secondary heat treatment at a temperature lower than that of the primary heat treatment to prepare a positive electrode active material, wherein the primary heat treatment and the secondary heat treatment are respectively performed in an oxygen atmosphere, and the secondary heat treatment is performed in the oxygen atmosphere with an oxygen concentration of 50% or more.

According to another aspect of the present invention, there is provided a positive electrode for a lithium secondary battery which includes a positive electrode collector; and a positive electrode active material layer formed on the positive electrode collector, wherein the positive electrode active material layer includes the positive electrode active material according to the present invention.

According to another aspect of the present invention, there is provided a lithium secondary battery including the positive electrode according to the present invention; a negative electrode; a separator disposed between the positive electrode and the negative electrode; and an electrolyte.

### Advantageous Effects

According to the present invention, a positive electrode active material, which includes a center portion having a layered structure and a surface portion having a secondary phase with a structure different from that of the center portion, may be prepared by controlling a heat treatment condition during the preparation of positive electrode active material particles. Specifically, a positive electrode active material having improved structural stability may be prepared by having the layered structure in the center portion of the positive electrode active material particle and having the secondary phase (spinel structure and/or rock-salt structure) with a structure different from that of the center portion only in the surface portion, specifically, a region located within 30 nm from a surface of the particle in a center direction.

Also, since life characteristics are improved by improving the structural stability as described above, a lithium secondary battery having long lifetime may be prepared.

### BRIEF DESCRIPTION OF THE DRAWINGS

FIG. 1 is a schematic view illustrating a positive electrode active material particle according to the present invention;

FIG. 2 is small angle diffraction pattern (SADP) data showing a layered structure of a positive electrode active material particle;

FIG. 3 is SADP data showing a rock-salt structure of a positive electrode active material particle; and

FIG. 4 is SADP data showing a spinel structure of a positive electrode active material particle.

### DESCRIPTION OF THE SYMBOLS

100: Positive electrode active material particle
10: Center portion
20: Surface portion

### MODE FOR CARRYING OUT THE INVENTION

Hereinafter, the present invention will be described in more detail.

It will be understood that words or terms used in the specification and claims shall not be interpreted as the meaning defined in commonly used dictionaries, and it will be further understood that the words or terms should be interpreted as having a meaning that is consistent with their meaning in the context of the relevant art and the technical idea of the invention, based on the principle that an inventor may properly define the meaning of the words or terms to best explain the invention.

With respect to a lithium nickel cobalt manganese oxide used as a conventional positive electrode active material for a lithium secondary battery, structural stability of the positive electrode active material is low, and there is a limitation in that the structural stability of the positive electrode active material is further reduced particularly when a large amount of nickel is included to prepare a high-capacity battery.

In order to compensate for this limitation, research to improve the structural stability by doping the positive electrode active material with a metallic element or metal oxide has been actively conducted. However, in a case in which the positive electrode active material is doped by using the metallic element as a doping raw material, since there is a limit to the improvement of the structural stability, the positive electrode active material must be accompanied by a coating layer, and, accordingly, there were limitations such as an increase in unit price or a decrease in energy density.

Thus, the present inventors have found that a secondary phase is formed on a surface of a layer-structured lithium transition metal oxide by controlling a heat treatment condition during the preparation of the lithium nickel cobalt manganese oxide, and a positive electrode active material having improved structural stability may be prepared, thereby leading to the completion of the present invention.

(Positive Electrode Active Material)

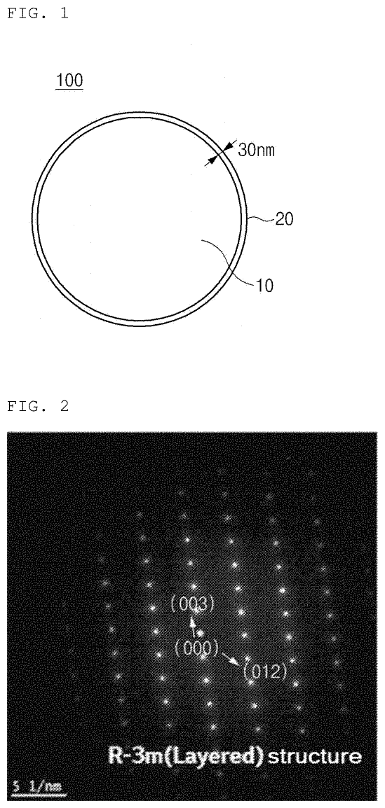

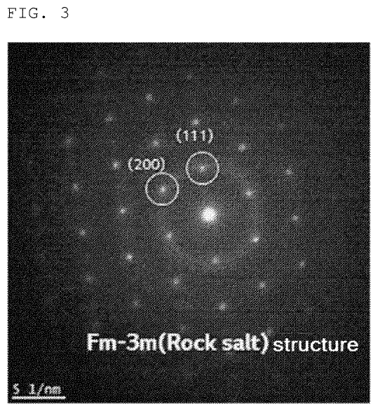

First, as illustrated in FIG. 1, a positive electrode active material particle 100 according to the present invention includes a lithium transition metal oxide, wherein the lithium transition metal oxide includes a center portion 10 having a layered structure and a surface portion 20 having a secondary phase with a structure different from that of the center portion.

Specifically, an average composition of the lithium transition metal oxide may preferably be represented by Formula 1 below.

Li₁₊ₐ(NiₓCo_{y}M¹_{z}M²_{w})₁₋ₐO₂ [Formula 1]

In Formula 1,

0≤a≤0.2, 0.6≤x≤1, 0≤y≤0.4, 0≤z≤0.4, and 0≤w≤0.1, for example, 0≤a≤0.1, 0.7≤x≤1, 0≤y≤0.3, 0≤z≤0.3, and 0≤w≤0.05.

M¹ includes at least one selected from the group consisting of manganese (Mn) and aluminum (Al), and M² includes at least one selected from the group consisting of zirconium (Zr), boron (B), tungsten (W), molybdenum (Mo), chromium (Cr), tantalum (Ta), niobium (Nb), magnesium (Mg), cerium (Ce), hafnium (Hf), lanthanum (La), titanium (Ti), strontium (Sr), barium (Ba), fluorine (F), phosphorus (P), sulfur (S), and yttrium (Y).

High capacity of a battery may be achieved when the battery is prepared by using the lithium transition metal oxide in which an amount of nickel is greater than 60 mol % based on the total number of moles of transition metals excluding lithium as described above.

The positive electrode active material includes a center portion having a layered structure and a surface portion having a secondary phase with a structure different from that of the center portion.

The expression “layered structure” denotes a structure in which planes of atoms strongly bonded by covalent bonds or the like and densely arranged are overlapped in parallel by a weak binding force such as a van der Waals force. With respect to a lithium transition metal oxide having a layered structure, intercalation and deintercalation of lithium ions are possible because the lithium ions, transition metal ions, and oxygen ions are densely arranged, specifically, a metal oxide layer composed of transition metal and oxygen and an oxygen octahedral layer surrounding lithium are alternatingly arranged with each other, and a Coulomb repulsive force acts between the metal oxide layers, and ionic conductivity is high because the lithium ions diffuse along a two-dimensional plane.

Thus, with respect to the positive electrode active material having a layered structure, since the lithium ions may quickly and smoothly move in the particle to facilitate the intercalation and deintercalation of the lithium ions, initial internal resistance of the battery may be reduced, and thus, discharge capacity and life characteristics may be further improved without worrying about the degradation of rate capability and initial capacity characteristics.

The surface portion having a secondary phase with a structure different from that of the center portion denotes a region located within 30 nm from a surface of the positive electrode active material particle toward the center of the particle, in which the secondary phase with a structure different from the layered structure of the center portion is present.

The surface portion may include at least one of a spinel structure and a rock-salt structure.

The expression “spinel structure” denotes that a metal oxide layer composed of transition metal and oxygen and an oxygen octahedral layer surrounding lithium are in a three-dimensional arrangement as shown in FIG. 4. Specifically, a lithium transition metal oxide having a spinel structure may be represented by a structure of LiMeₓ₁Mn₂₋ₓ₁O₄ (where Me includes at least two selected from the group consisting of Ni, Co, and Al), wherein, since Mn³⁺ is substituted with a transition metal ion (at least one selected from the group consisting of Ni²⁺, Co²⁺, and Al³⁺) with an oxidation number of 3+ or less, Mn sites are substituted with a metal with an oxidation number of 2+ or 3+ to increase an average valence of Mn, and thus, stability of the lithium transition metal oxide may be improved.

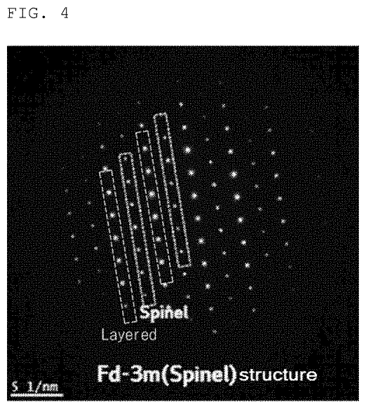

The expression “rock-salt structure” denotes a face-centered cubic structure in which a metal atomic coordinated by surrounding six oxygen atoms arranged in an octahedral form as shown in FIG. 3. A compound having the rock-salt structure has high structural stability, particularly, high structural stability at high temperature.

In a case in which the lithium transition metal oxide having the secondary phase, which includes at least one of the spinel structure and the rock-salt structure on the surface of the lithium transition metal oxide having the layered structure, is formed as described, structural stability and thermal stability of the positive electrode active material may be improved due to the formation of the secondary phase.

Particularly, in a case in which the surface portion is present only in the region located within 30 nm from the surface of the particle in the center direction, an effect of improving the structural stability and thermal stability may be more significant, and life characteristics of the secondary battery may be improved when the positive electrode active material is used in the battery.

In contrast, in a case in which a single phase is present over the entire positive electrode active material particle or a ratio of the secondary phase increases throughout the particle because the secondary phase is present even beyond 30 nm from the surface of the particle in the center direction, the life characteristics may be degraded when the positive electrode active material particles are used in the battery.

An average particle diameter (D₅₀) of the positive electrode active material particles may be in a range of 4 μm to 20 μm in consideration of convenience during preparation process and electrode application process, and may more preferably be in a range of 8 μm to 14 μm.

The average particle diameter D₅₀ of the positive electrode active material particles may be defined as a particle diameter at 50% in a cumulative particle diameter distribution. In the present invention, the particle diameter distribution of the positive electrode active material particles, for example, may be measured by using a laser diffraction method. Specifically, with respect to the particle distribution of the positive electrode active material, after particles of the positive electrode active material are dispersed in a dispersion medium, the dispersion medium is introduced into a commercial laser diffraction particle size measurement instrument (e.g., Microtrac MT 3000) and irradiated with ultrasonic waves having a frequency of about 28 kHz and an output of 60 W, and the average particle diameter at 50% in a cumulative particle diameter distribution of the measurement instrument may then be calculated.

(Method of Preparing Positive Electrode Active Material)

A method of preparing a positive electrode active material according to the present invention which includes: mixing a positive electrode active material precursor with a lithium raw material and performing a primary heat treatment; and performing a secondary heat treatment at a temperature lower than that of the primary heat treatment to prepare a positive electrode active material, wherein the primary heat treatment and the secondary heat treatment are respectively performed in an oxygen atmosphere, and the secondary heat treatment is performed in the oxygen atmosphere with an oxygen concentration of 50% or more.

Hereinafter, the method of preparing a positive electrode active material according to the present invention will be described in more detail.

First, a positive electrode active material precursor and a lithium raw material are mixed and a primary heat treatment is performed.

The positive electrode active material precursor may contain nickel in an amount of greater than 60 mol % based on a total number of moles of transition metals, and may preferably be represented by Niₓ₁Co_{y1}M¹_{z1}M²_{w1} (OH)₂ (where 0.6<x1≤1, 0<y1≤0.4, 0<z1≤0.4, and 0≤w1≤0.1, M¹ includes at least one selected from the group consisting of Mn and Al, and M² includes at least one selected from the group consisting of Zr, B, W, Mo, Cr, Ta, Nb, Mg, Ce, Hf, La, Ti, Sr, Ba, F, P, S, and Y).

In a case in which the amount of the nickel is greater than 60 mol % based on the total number of moles of the transition metals in the positive electrode active material precursor as described above, high capacity of a battery may be achieved when the battery is prepared by using the precursor.

Also, the lithium raw material may be used without particular limitation as long as it is a compound including a lithium source, but, preferably, at least one selected from the group consisting of lithium carbonate (Li₂CO₃), lithium hydroxide (LiOH), LiNO₃, CH₃COOLi, and Li₂(COO)₂ may be used.

Furthermore, the positive electrode active material precursor and the lithium raw material may be mixed such that a molar ratio (Li/transition metal) of lithium to transition metal is in a range of 1 to 1.2, preferably 1 to 1.1, and more preferably 1 to 1.05. In a case in which the positive electrode active material precursor and the lithium raw material are mixed within the above range, a positive electrode active material exhibiting excellent capacity characteristics may be prepared.

The primary heat treatment may be performed at 800° C. or more, preferably 800° C. to 900° C., and more preferably 800° C. to 850° C. for 10 hours to 20 hours, for example, 12 hours to 16 hours.

Also, the primary heat treatment may be performed in an oxygen atmosphere with an oxygen concentration of 50% or more. In a case in which the primary heat treatment is performed in the oxygen atmosphere with an oxygen concentration of 50% or more, it is possible to promote a reaction of the positive electrode active material precursor with the lithium. For example, in a case in which the primary heat treatment is performed in an air atmosphere or an inert atmosphere, the reaction of the positive electrode active material precursor with the lithium does not proceed smoothly, and, accordingly, unreacted lithium may remain on the surface of the positive electrode active material. Due to the residual unreacted lithium, an amount of gas generated may be increased by a reaction of an electrolyte solution with the unreacted lithium present on the surface of the positive electrode active material when the positive electrode active material is used a battery, and, accordingly, the battery may be expanded.

Subsequently, after the primary heat treatment is performed, a secondary heat treatment may be performed at a temperature lower than that of the primary heat treatment.

The performing of the secondary heat treatment after the primary heat treatment may be performed by cooling to a room temperature after the primary heat treatment and then again performing the secondary heat treatment or may be performed by performing the secondary heat treatment immediately after the primary heat treatment.

In this case, the secondary heat treatment may be performed at a temperature of greater than 600° C. to less than 800° C., for example, 650° C. to 750° C. for 2 hours to 12 hours, for example, 3 hours to 7 hours in an oxygen atmosphere with an oxygen concentration of 50% or more.

In a case in which the secondary heat treatment is performed at a temperature of greater than 600° C. to less than 800° C. in the oxygen atmosphere with an oxygen concentration of 50% or more as in the present invention, a secondary phase with a structure different from a layered structure may be formed on a surface of a lithium transition metal oxide having the layered structure. In this case, the surface of the lithium transition metal oxide denotes a region located within 30 nm from the surface of the lithium transition metal oxide in a center direction.

In contrast, in a case in which any one of the oxygen concentration or heat treatment temperature during the secondary heat treatment does not satisfy the above range, the secondary phase formed on the surface of the lithium transition metal oxide as described above is not only present in the region located within 30 nm from the surface of the lithium transition metal oxide in the center direction, but also the secondary phase may be present over the entire positive electrode active material, or secondary phases with a layered structure and with a structure different from the layered structure may be present in a mixed state over the entire positive electrode active material particle.

(Positive Electrode)

Also, provided is a positive electrode for a lithium secondary battery including the positive electrode active material according to the present invention. Specifically, provided is the positive electrode for a lithium secondary battery which includes a positive electrode collector, and a positive electrode active material layer formed on the positive electrode collector, wherein the positive electrode active material layer includes the positive electrode active material according to the present invention.

In this case, since the positive electrode active material is the same as described above, detailed descriptions thereof will be omitted, and the remaining configurations will be only described in detail below.

The positive electrode collector may include a metal with high conductivity, wherein the positive electrode collector is not particularly limited as long as it is easily bonded to the positive electrode active material layer, but is not reactive in a voltage range of the battery. For example, stainless steel, aluminum, nickel, titanium, fired carbon, or aluminum or stainless steel that is surface-treated with one of carbon, nickel, titanium, silver, or the like may be used as the positive electrode collector. Also, the positive electrode collector may typically have a thickness of 3 μm to 500 μm, and microscopic irregularities may be formed on the surface of the collector to improve the adhesion of the positive electrode active material. The positive electrode collector, for example, may be used in various shapes such as that of a film, a sheet, a foil, a net, a porous body, a foam body, a non-woven fabric body, and the like.

The positive electrode active material layer may selectively include a conductive agent, a binder, and a dispersant, if necessary, in addition to the above positive electrode active material.

In this case, the positive electrode active material may be included in an amount of 80 wt % to 99 wt %, for example, 85 wt % to 98.5 wt % based on a total weight of the positive electrode active material layer. When the positive electrode active material is included in an amount within the above range, excellent capacity characteristics may be obtained.

The conductive agent is used to provide conductivity to the electrode, wherein any conductive agent may be used without particular limitation as long as it has suitable electron conductivity without causing adverse chemical changes in the battery. Specific examples of the conductive agent may be graphite such as natural graphite or artificial graphite; carbon based materials such as carbon black, acetylene black, Ketjen black, channel black, furnace black, lamp black, thermal black, and carbon fibers; powder or fibers of metal such as copper, nickel, aluminum, and silver; conductive whiskers such as zinc oxide whiskers and potassium titanate whiskers; conductive metal oxides such as titanium oxide; or conductive polymers such as polyphenylene derivatives, and any one thereof or a mixture of two or more thereof may be used. The conductive agent may be typically included in an amount of 0.1 wt % to 15 wt % based on the total weight of the positive electrode active material layer.

The binder improves the adhesion between the positive electrode active material particles and the adhesion between the positive electrode active material and the current collector. Specific examples of the binder may be polyvinylidene fluoride (PVDF), a polyvinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinylpyrrolidone, tetrafluoroethylene, polyethylene, polypropylene, an ethylene-propylene-diene monomer (EPDM), a sulfonated EPDM, a styrene-butadiene rubber (SBR), a fluorine rubber, poly acrylic acid, and a polymer having hydrogen thereof substituted with lithium (Li), sodium (Na), or calcium (Ca), or various copolymers thereof, and any one thereof or a mixture of two or more thereof may be used. The binder may be included in an amount of 0.1 wt % to 15 wt % based on the total weight of the positive electrode active material layer.

The dispersant may include an aqueous dispersant or an organic dispersant such as N-methyl-2-pyrrolidone.

The positive electrode may be prepared according to a typical method of preparing a positive electrode except that the above-described positive electrode active material is used. Specifically, a composition for forming a positive electrode active material layer, which is prepared by dissolving or dispersing the positive electrode active material as well as selectively the binder, the conductive agent, and the dispersant, if necessary, in a solvent, is coated on the positive electrode collector, and the positive electrode may then be prepared by drying and rolling the coated positive electrode collector.

The solvent may be a solvent normally used in the art. The solvent may include dimethyl sulfoxide (DMSO), isopropyl alcohol, N-methyl pyrrolidone (NMP), acetone, or water, and any one thereof or a mixture of two or more thereof may be used. An amount of the solvent used may be sufficient if the solvent may dissolve or disperse the positive electrode active material, the conductive agent, the binder, and the dispersant in consideration of a coating thickness of a slurry and manufacturing yield, and may allow to have a viscosity that may provide excellent thickness uniformity during the subsequent coating for the preparation of the positive electrode.

Also, as another method, the positive electrode may be prepared by casting the composition for forming a positive electrode active material layer on a separate support and then laminating a film separated from the support on the positive electrode collector.

(Secondary Battery)

Furthermore, in the present invention, an electrochemical device including the positive electrode may be prepared. The electrochemical device may specifically be a battery or a capacitor, and, for example, may be a lithium secondary battery.

The lithium secondary battery specifically includes a positive electrode, a negative electrode disposed to face the positive electrode, a separator disposed between the positive electrode and the negative electrode, and an electrolyte, wherein, since the positive electrode is the same as described above, detailed descriptions thereof will be omitted, and the remaining configurations will be only described in detail below.

Also, the lithium secondary battery may further selectively include a battery container accommodating an electrode assembly of the positive electrode, the negative electrode, and the separator, and a sealing member sealing the battery container.

Furthermore, the lithium secondary battery may further include a current interrupt device for stopping charging the battery by detecting a change in volume in the battery.

The current interrupt device (CID) senses a pressure change in the battery, wherein, when an internal pressure of the battery rises above a predetermined pressure, the CID may be activated to stop charging the battery. The current interrupt device may preferably be connected to the sealing member and may operate to block a current from the outside when the internal pressure of the battery rises.

In the lithium secondary battery, the negative electrode includes a negative electrode collector and a negative electrode active material layer disposed on the negative electrode collector.

The negative electrode collector is not particularly limited as long as it has high conductivity without causing adverse chemical changes in the battery, and, for example, copper, stainless steel, aluminum, nickel, titanium, fired carbon, copper or stainless steel that is surface-treated with one of carbon, nickel, titanium, silver, or the like, and an aluminum-cadmium alloy may be used. Also, the negative electrode collector may typically have a thickness of 3 μm to 500 μm, and, similar to the positive electrode collector, microscopic irregularities may be formed on the surface of the collector to improve the adhesion of a negative electrode active material. The negative electrode collector, for example, may be used in various shapes such as that of a film, a sheet, a foil, a net, a porous body, a foam body, a non-woven fabric body, and the like.

The negative electrode active material layer selectively includes a binder and a conductive agent in addition to the negative electrode active material.

A compound capable of reversibly intercalating and deintercalating lithium may be used as the negative electrode active material. Specific examples of the negative electrode active material may be a carbonaceous material such as artificial graphite, natural graphite, graphitized carbon fibers, and amorphous carbon; a metallic compound alloyable with lithium such as silicon (Si), aluminum (Al), tin (Sn), lead (Pb), zinc (Zn), bismuth (Bi), indium (In), magnesium (Mg), gallium (Ga), cadmium (Cd), a Si alloy, a Sn alloy, or an Al alloy; a metal oxide which may be doped and undoped with lithium such as SiO_{β}(0<β<2), SnO₂, vanadium oxide, and lithium vanadium oxide; or a composite including the metallic compound and the carbonaceous material such as a Si—C composite or a Sn—C composite, and any one thereof or a mixture of two or more thereof may be used. Also, a metallic lithium thin film may be used as the negative electrode active material. Furthermore, both low crystalline carbon and high crystalline carbon may be used as the carbon material. Typical examples of the low crystalline carbon may be soft carbon and hard carbon, and typical examples of the high crystalline carbon may be irregular, planar, flaky, spherical, or fibrous natural graphite or artificial graphite, Kish graphite, pyrolytic carbon, mesophase pitch-based carbon fibers, meso-carbon microbeads, mesophase pitches, and high-temperature sintered carbon such as petroleum or coal tar pitch derived cokes.

The negative electrode active material may be included in an amount of 80 wt % to 99 wt % based on a total weight of the negative electrode active material layer.

The binder is a component that assists in the binding between the conductive agent, the active material, and the current collector, wherein the binder is typically added in an amount of 0.1 wt % to 10 wt % based on the total weight of the negative electrode active material layer. Examples of the binder may be polyvinylidene fluoride (PVDF), polyvinyl alcohol, carboxymethylcellulose (CMC), starch, hydroxypropylcellulose, regenerated cellulose, polyvinylpyrrolidone, tetrafluoroethylene, polyethylene, polypropylene, an ethylene-propylene-diene polymer (EPDM), a sulfonated-EPDM, a styrene-butadiene rubber, a nitrile-butadiene rubber, a fluoro rubber, and various copolymers thereof.

The conductive agent is a component for further improving conductivity of the negative electrode active material, wherein the conductive agent may be added in an amount of 10 wt % or less, for example, 5 wt % or less based on the total weight of the negative electrode active material layer. The conductive agent is not particularly limited as long as it has conductivity without causing adverse chemical changes in the battery, and, for example, a conductive material such as: graphite such as natural graphite or artificial graphite; carbon black such as acetylene black, Ketjen black, channel black, furnace black, lamp black, and thermal black; conductive fibers such as carbon fibers or metal fibers; metal powder such as fluorocarbon powder, aluminum powder, and nickel powder; conductive whiskers such as zinc oxide whiskers and potassium titanate whiskers; conductive metal oxide such as titanium oxide; or polyphenylene derivatives may be used.

For example, the negative electrode active material layer may be prepared by coating a composition for forming a negative electrode, which is prepared by dissolving or dispersing selectively the binder and the conductive agent as well as the negative electrode active material in a solvent, on the negative electrode collector and drying the coated negative electrode collector, or may be prepared by casting the composition for forming a negative electrode on a separate support and then laminating a film separated from the support on the negative electrode collector.

In the lithium secondary battery, the separator separates the negative electrode and the positive electrode and provides a movement path of lithium ions, wherein any separator may be used as the separator without particular limitation as long as it is typically used in a lithium secondary battery, and particularly, a separator having high moisture-retention ability for an electrolyte as well as low resistance to the transfer of electrolyte ions may be used. Specifically, a porous polymer film, for example, a porous polymer film prepared from a polyolefin-based polymer, such as an ethylene homopolymer, a propylene homopolymer, an ethylene/butene copolymer, an ethylene/hexene copolymer, and an ethylene/methacrylate copolymer, or a laminated structure having two or more layers thereof may be used. Also, a typical porous nonwoven fabric, for example, a nonwoven fabric formed of high melting point glass fibers or polyethylene terephthalate fibers may be used. Furthermore, a coated separator including a ceramic component or a polymer material may be used to secure heat resistance or mechanical strength, and the separator having a single layer or multilayer structure may be selectively used.

Also, the electrolyte used in the present invention may include an organic liquid electrolyte, an inorganic liquid electrolyte, a solid polymer electrolyte, a gel-type polymer electrolyte, a solid inorganic electrolyte, or a molten-type inorganic electrolyte which may be used in the preparation of the lithium secondary battery, but the present invention is not limited thereto.

Specifically, the electrolyte may include an organic solvent and a lithium salt.

Any organic solvent may be used as the organic solvent without particular limitation so long as it may function as a medium through which ions involved in an electrochemical reaction of the battery may move. Specifically, an ester-based solvent such as methyl acetate, ethyl acetate, γ-butyrolactone, and ϵ-caprolactone; an ether-based solvent such as dibutyl ether or tetrahydrofuran; a ketone-based solvent such as cyclohexanone; an aromatic hydrocarbon-based solvent such as benzene and fluorobenzene; or a carbonate-based solvent such as dimethyl carbonate (DMC), diethyl carbonate (DEC), methylethyl carbonate (MEC), ethylmethyl carbonate (EMC), ethylene carbonate (EC), and propylene carbonate (PC); an alcohol-based solvent such as ethyl alcohol and isopropyl alcohol; nitriles such as R—CN (where R is a linear, branched, or cyclic C2-C20 hydrocarbon groupand may include a double-bond aromatic ring or ether bond); amides such as dimethylformamide; dioxolanes such as 1,3-dioxolane; or sulfolanes may be used as the organic solvent. Among these solvents, the carbonate-based solvent may be used, and, for example, a mixture of a cyclic carbonate (e.g., ethylene carbonate or propylene carbonate) having high ionic conductivity and high dielectric constant, which may increase charge/discharge performance of the battery, and a low-viscosity linear carbonate-based compound (e.g., ethylmethyl carbonate, dimethyl carbonate, or diethyl carbonate) may be used. In this case, the performance of the electrolyte solution may be excellent when the cyclic carbonate and the chain carbonate are mixed in a volume ratio of about 1:1 to about 1:9.

The lithium salt may be used without particular limitation as long as it is a compound capable of providing lithium ions used in the lithium secondary battery. Specifically, an anion of the lithium salt may include at least one selected from the group consisting of F⁻, Cl⁻, Br⁻, I⁻, NO₃⁻, N(CN)₂⁻, BF₄⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻, and LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI, or LiB(C₂O₄)₂ may be used as the lithium salt. The lithium salt may be used in a concentration range of 0.1 M to 2.0 M. In a case in which the concentration of the lithium salt is included within the above range, since the electrolyte may have appropriate conductivity and viscosity, excellent performance of the electrolyte may be obtained and lithium ions may effectively move.

In order to improve life characteristics of the battery, suppress the reduction in battery capacity, and improve discharge capacity of the battery, at least one additive, for example, a halo-alkylene carbonate-based compound such as difluoroethylene carbonate, pyridine, triethylphosphite, triethanolamine, cyclic ether, ethylenediamine, n-glyme, hexaphosphorictriamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further added to the electrolyte in addition to the electrolyte components. In this case, the additive may be included in an amount of 0.1 wt % to 5 wt % based on a total weight of the electrolyte.

As described above, since the lithium secondary battery including the positive electrode active material according to the present invention stably exhibits excellent discharge capacity, output characteristics, and life characteristics, the lithium secondary battery is suitable for portable devices, such as mobile phones, notebook computers, and digital cameras, and electric cars such as hybrid electric vehicles (HEVs).

Thus, according to another embodiment of the present invention, a battery module including the lithium secondary battery as a unit cell and a battery pack including the battery module are provided.

The battery module or the battery pack may be used as a power source of at least one medium and large sized device of a power tool; electric cars including an electric vehicle (EV), a hybrid electric vehicle, and a plug-in hybrid electric vehicle (PHEV); or a power storage system.

A shape of the lithium secondary battery of the present invention is not particularly limited, but a cylindrical type using a can, a prismatic type, a pouch type, or a coin type may be used.

The lithium secondary battery according to the present invention may not only be used in a battery cell that is used as a power source of a small device, but may also be used as a unit cell in a medium and large sized battery module including a plurality of battery cells.

Examples of the medium and large sized device may be an electric vehicle, a hybrid electric vehicle, a plug-in hybrid electric vehicle, and a power storage system, but the present invention is not limited thereto.

Hereinafter, the present invention will be described in detail, according to specific examples. The invention may, however, be embodied in many different forms and should not be construed as being limited to the embodiments set forth herein. Rather, these example embodiments are provided so that this description will be thorough and complete, and will fully convey the scope of the present invention to those skilled in the art.

### EXAMPLES

### Example 1

Ni_{0.8}Co_{0.1}Mn_{0.1}(OH)₂ and LiOH were mixed in a molar ratio of 1:1.02, and a primary heat treatment was performed at 800° C. for 14 hours in an oxygen atmosphere. Subsequently, a secondary heat treatment was performed at 700° C. for 5 hours in a 100% oxygen atmosphere to prepare a LiNi_{0.6}Co_{0.2}Mn_{0.2}O₂ positive electrode active material.

The above-prepared positive electrode active material, a carbon black conductive agent, and a polyvinylidene fluoride binder were mixed in a weight ratio of 95:3:2 in an N-methyl pyrrolidone (NMP) solvent to prepare a composition for forming a positive electrode. A 20 μm thick aluminum thin film was coated with the composition for forming a positive electrode, dried at 130° C. for 2 hours, and then roll-pressed to prepare a positive electrode.

A lithium metal foil was used as a negative electrode.

After the above-prepared positive electrode and negative electrode were stacked with a polyethylene separator (Tonen Chemical Corporation, F20BHE, thickness: 20 μm) to prepare a polymer type battery by a conventional method, the polymer type battery was put in a battery case, an electrolyte solution, in which 1 M LiPF₆ was dissolved in a mixed solvent in which ethylene carbonate (EC) and ethyl methyl carbonate (EMC) were mixed in a volume ratio of 1:2, was injected thereinto to prepare a coin cell-type lithium secondary battery.

### Example 2

A positive electrode active material and a lithium secondary battery including the same were prepared in the same manner as in Example 1 except that a secondary heat treatment was performed at 700° C. for 5 hours in a 80% oxygen atmosphere during the secondary heat treatment.

### Example 3

A positive electrode active material and a lithium secondary battery including the same were prepared in the same manner as in Example 1 except that a secondary heat treatment was performed at 700° C. for 5 hours in a 50% oxygen atmosphere during the secondary heat treatment.

### Example 4

A positive electrode active material and a lithium secondary battery including the same were prepared in the same manner as in Example 1 except that a secondary heat treatment was performed at 750° C. for 4 hours in a 100% oxygen atmosphere during the secondary heat treatment.

### Example 5

A positive electrode active material and a lithium secondary battery including the same were prepared in the same manner as in Example 1 except that a secondary heat treatment was performed at 750° C. for 5 hours in a 80% oxygen atmosphere during the secondary heat treatment.

### Example 6

A positive electrode active material and a lithium secondary battery including the same were prepared in the same manner as in Example 1 except that a secondary heat treatment was performed at 750° C. for 7 hours in a 50% oxygen atmosphere during the secondary heat treatment.

### Example 7

A positive electrode active material and a lithium secondary battery including the same were prepared in the same manner as in Example 1 except that a secondary heat treatment was performed at 650° C. for 7 hours in a 100% oxygen atmosphere during the secondary heat treatment.

### Example 8

A positive electrode active material and a lithium secondary battery including the same were prepared in the same manner as in Example 1 except that a secondary heat treatment was performed at 650° C. for 7 hours in a 80% oxygen atmosphere during the secondary heat treatment.

### Example 9

A positive electrode active material and a lithium secondary battery including the same were prepared in the same manner as in Example 1 except that a secondary heat treatment was performed at 650° C. for 5 hours in a 50% oxygen atmosphere during the secondary heat treatment.

### Comparative Example 1

A lithium secondary battery was prepared in the same manner as in Example 1 except that Ni_{0.8}Co_{0.1}Mn_{0.1}(OH)₂ and LiOH were mixed in a molar ratio of 1:1.02, a primary heat treatment was performed at 800° C. for 14 hours in an oxygen atmosphere to prepare a positive electrode active material, and the positive electrode active material was used.

### Comparative Example 2

A positive electrode active material and a lithium secondary battery including the same were prepared in the same manner as in Example 1 except that a secondary heat treatment was performed at 600° C. for 5 hours in a 100% oxygen atmosphere during the secondary heat treatment.

### Comparative Example 3

A positive electrode active material and a lithium secondary battery including the same were prepared in the same manner as in Example 1 except that a secondary heat treatment was performed at 700° C. for 5 hours in a 20% oxygen atmosphere during the secondary heat treatment.

### Comparative Example 4

A positive electrode active material and a lithium secondary battery including the same were prepared in the same manner as in Example 1 except that a secondary heat treatment was performed at 700° C. for 5 hours in a 40% oxygen atmosphere during the secondary heat treatment.

### Comparative Example 5

A positive electrode active material and a lithium secondary battery including the same were prepared in the same manner as in Example 1 except that a secondary heat treatment was performed at 800° C. for 5 hours in a 100% oxygen atmosphere during the secondary heat treatment.

### Comparative Example 6

A positive electrode active material and a lithium secondary battery including the same were prepared in the same manner as in Example 1 except that a secondary heat treatment was performed at 800° C. for 7 hours in a 80% oxygen atmosphere during the secondary heat treatment.

### Comparative Example 7

A positive electrode active material and a lithium secondary battery including the same were prepared in the same manner as in Example 1 except that a secondary heat treatment was performed at 800° C. for 7 hours in a 50% oxygen atmosphere during the secondary heat treatment.

### Experimental Example 1: Analysis of Surface Phase of Positive Electrode Active Material

A section of each positive electrode active material was cut to a thickness of 50 nm and a surface of the positive electrode active material was observed by using a transmission electron microscope (TEM) (FE-STEM, TITAN G2 80-100 ChemiSTEM), and a phase of the positive electrode active material was measured from a small angle diffraction pattern (SADP).

The presence of a secondary phase in a region (surface portion) located within 30 nm from a surface of a particle in a center direction and the presence of the secondary phase even in an inner side (center portion) beyond 30 nm from the surface of the particle were confirmed, and the results thereof are presented in Table 1 below. In a case in which the secondary phase was present in the surface portion as the region located within 30 nm from the surface of the particle in the center direction, it was indicated by O, and, in a case in which the secondary phase was not present, it was indicated by x. In addition, in a case in which the secondary phase was present even in the inner side beyond 30 nm from the surface of the particle, it was indicated by O, and, in a case in which the secondary phase was not present in the inner side beyond 30 nm from the surface of the particle, it was indicated by x.

TABLE 1

| | The presence | The presence |
|---|---|---|
| | of secondary | of secondary |
| | phase in | phase in center |
| | surface portion | portion |
| Example 1 | ∘ | x |
| Example 2 | ∘ | x |
| Example 3 | ∘ | x |
| Example 4 | ∘ | x |
| Example 5 | ∘ | x |
| Example 6 | ∘ | x |
| Example 7 | ∘ | x |
| Example 8 | ∘ | x |
| Example 9 | ∘ | x |
| Comparative Example 1 | x | x |
| Comparative Example 2 | x | x |
| Comparative Example 3 | ∘ | ∘ |
| Comparative Example 4 | ∘ | ∘ |
| Comparative Example 5 | ∘ | ∘ |
| Comparative Example 6 | ∘ | ∘ |
| Comparative Example 7 | ∘ | ∘ |

As illustrated in Table 1, with respect to the positive electrode active material particles prepared in Examples 1 and 2, it may be confirmed that the secondary phase was present in the surface portion as the region located within 30 nm from the surface of the particle in the center direction, but the secondary phase was not present in the center portion as the inner side beyond 30 nm from the surface in the center direction.

In contrast, with respect to Comparative Example 1 in which a secondary heat treatment was not performed, the secondary phase was not present in both the surface portion and the center portion.

Also, with respect to the positive electrode active material particles prepared in Comparative Examples 3 to 7, the secondary phase was present within 30 nm from the surface of the particle in the center direction, and the secondary phase was also present in the region located beyond 30 nm from the surface of the particle in the center direction.

With respect to the positive electrode active material particles prepared in Comparative Example 2, since the heat treatment temperature was low, the secondary phase was not present in the particle.

### Experimental Example 2: Evaluation of Charge and Discharge Capacity and Efficiency Characteristics

After the coin-type lithium secondary batteries respectively prepared in Examples 1 to 9 and Comparative Examples 1 to 7 were charged at a constant current of 0.2 C to 4.25 V at 25° C. and discharged at a constant current of 0.2 C to a voltage of 2.5 V, charge and discharge characteristics in the first cycle were observed, and the results thereof are presented in the following Table 2.

TABLE 2

| | Charge | Discharge |
|---|---|---|
| | capacity (mAh/g) | capacity (mAh/g) |
| Example 1 | 225 | 200 |
| Example 2 | 225 | 199 |
| Example 3 | 225 | 198 |
| Example 4 | 226 | 202 |
| Example 5 | 226 | 201 |
| Example 6 | 226 | 200 |
| Example 7 | 224 | 199 |
| Example 8 | 224 | 198 |
| Example 9 | 224 | 197 |
| Comparative Example 1 | 225 | 203 |
| Comparative Example 2 | 225 | 202 |
| Comparative Example 3 | 225 | 194 |
| Comparative Example 4 | 225 | 195 |
| Comparative Example 5 | 224 | 190 |
| Comparative Example 6 | 224 | 188 |
| Comparative Example 7 | 224 | 186 |

As illustrated in Table 2, with respect to the coin-type lithium secondary batteries prepared in Examples 1 to 7, it may be confirmed that charge and discharge efficiencies better than those of the lithium secondary batteries prepared in Comparative Examples 3 to 7 may be obtained.

### Experimental Example 3: Hot Box Test

Hot box tests were performed using the coin-type lithium secondary batteries respectively prepared in Examples 1 to 9 and Comparative Examples 1 to 7.

Specifically, the coin-type lithium secondary batteries respectively prepared in Examples 1 to 9 and Comparative Examples 1 to 7 were put in an oven, and the temperature was increased at a rate of 10° C./min and maintained for 30 minutes at 150° C. Whether or not the battery had exploded was confirmed during the hot box tests, and the results thereof are presented in Table 3 below.

In this case, a case where the explosion of the secondary battery did not occur was indicated by O, and a case where the explosion occurred was indicated by x.

### Experimental Example 4: Overcharge Test

Cylindrical type batteries were prepared by using the positive electrode active materials respectively prepared in Examples 1 to 9 and Comparative Examples 1 to 7 and overcharge tests were then performed.

Specifically, each of the cylindrical type batteries after the completion of activation was charged at a constant current of 0.2 C to 4.25 V and cut-off charged at 0.01 C. Thereafter, each of the cylindrical type batteries was discharged at a constant current of 0.2 C to a voltage of 2.5 V. Thereafter, each cylindrical type battery was charged at a constant current of 0.5 C until a current interrupt device (CID) of the cylindrical type battery was activated, and a temperature of the cell in this case was measured.

The overcharge test results are presented in Table 3 below. A case where the temperature of the battery was increased to 150° C. or more after the activation of the current interrupt device (CID) was considered as overcharge test failure, and this was indicated by x. A case where the temperature of the battery was increased to less than 150° C. after the activation of the current interrupt device (CID) was considered that the overcharge test results were stable, and this was indicated by O.

TABLE 3

| | | Whether the |
|---|---|---|
| | Whether the | overcharge |
| | hot box test | test was |
| | was passed | passed |
| | or not | or not |
| Example 1 | ∘ | ∘ |
| Example 2 | ∘ | ∘ |
| Example 3 | ∘ | ∘ |
| Example 4 | ∘ | ∘ |
| Example 5 | ∘ | ∘ |
| Example 6 | ∘ | ∘ |
| Example 7 | ∘ | ∘ |
| Example 8 | ∘ | ∘ |
| Example 9 | ∘ | ∘ |
| Comparative Example 1 | x | x |
| Comparative Example 2 | x | x |
| Comparative Example 3 | ∘ | ∘ |
| Comparative Example 4 | ∘ | ∘ |
| Comparative Example 5 | ∘ | ∘ |
| Comparative Example 6 | ∘ | ∘ |
| Comparative Example 7 | ∘ | ∘ |

Referring to Table 3, it was confirmed that the lithium secondary batteries prepared in Examples 1 to 9 and Comparative Examples 3 to 7 all passed the hot box test and the overcharge test.

In contrast, it may be confirmed that Comparative Examples 1 and 2 did not pass the hot box test and the overcharge test.

Thus, the positive electrode active materials prepared in Comparative Examples 1 and 2 and the lithium secondary batteries including the same had lower stability than the lithium secondary batteries of Examples 1 to 9, and, accordingly, it was predicted that there will be a battery explosion problem due to the stability problem when the positive electrode active material is used in the secondary battery even if the charge and discharge efficiency was excellent.

### Experimental Example 5: Life Characteristics Evaluation

Life characteristics of the coin-type lithium secondary batteries respectively prepared in Examples 1 to 9 and Comparative Examples 1 to 7 were measured.

Specifically, each of the coin-type batteries respectively prepared in Examples 1 to 9 and Comparative Examples 1 to 7 was charged at a constant current of 0.2 C to 4.25 V at 45° C. and cut-off charged at 0.01 C. Thereafter, initial discharge was performed at a constant current of 0.2 C to a voltage of 2.5 V. Subsequently, each coin-type battery was charged at a constant current of 0.5 C to 4.25 V and cut-off charged at 0.01 C, and, thereafter, was discharged at a constant current of 0.5 C to a voltage of 2.5 V. The charging and discharging behaviors were set as one cycle, and, after this cycle was repeated 50 times, the life characteristics of the lithium secondary batteries according to Examples 1 to 9 and Comparative Examples 1 to 7 were measured. The results thereof are presented in Table 4 below.

TABLE 4

| | Capacity |
|---|---|
| | retention (%) |
| Example 1 | 96 |
| Example 2 | 95 |
| Example 3 | 96 |
| Example 4 | 95 |
| Example 5 | 96 |
| Example 6 | 96 |
| Example 7 | 96 |
| Example 8 | 95 |
| Example 9 | 96 |
| Comparative Example 1 | 85 |
| Comparative Example 2 | 86 |
| Comparative Example 3 | 85 |
| Comparative Example 4 | 84 |
| Comparative Example 5 | 86 |
| Comparative Example 6 | 85 |
| Comparative Example 7 | 84 |

As illustrated in Table 4, it may be confirmed that the lithium secondary batteries of Examples 1 to 9 in which the secondary phase was only present in the surface portion of the positive electrode active material particles had better life characteristics than the lithium secondary batteries of Comparative Examples 1 and 2, in which the secondary phase was not present, and the lithium secondary batteries of Comparative Examples 3 to 7 in which the secondary phase was not only present in the surface portion of the positive electrode active material particles, but was also present in the inner side beyond 30 nm from the surface.

1. A positive electrode active material comprising a lithium transition metal oxide represented by Formula 1,
wherein the lithium transition metal oxide comprises a center portion having a layered structure and a surface portion having a secondary phase with a structure different from that of the center portion:
Li₁₊ₐ(NiₓCo_{y}M¹_{z}M²_{w})₁₋ₐO₂ [Formula 1]
wherein, in Formula 1,
0≤a≤0.2, 0.6<x≤1, 0<y≤0.4, 0<z≤0.4, and 0≤w≤0.1,
M¹ comprises at least one selected from the group consisting of manganese (Mn) and aluminum (Al), and
M² comprises at least one selected from the group consisting of zirconium (Zr), boron (B), tungsten (W), molybdenum (Mo), chromium (Cr), tantalum (Ta), niobium (Nb), magnesium (Mg), cerium (Ce), hafnium (Hf), lanthanum (La), titanium (Ti), strontium (Sr), barium (Ba), fluorine (F), phosphorus (P), sulfur (S), and yttrium (Y).

2. The positive electrode active material of claim 1, wherein the surface portion is a region located within 30 nm from a surface of a particle toward a center of the particle.

3. The positive electrode active material of claim 1, wherein the surface portion comprises at least one selected from a spinel structure or a rock-salt structure.

4. A method of preparing a positive electrode active material, the method comprising:
mixing a positive electrode active material precursor with a lithium raw material and performing a primary heat treatment; and
performing a secondary heat treatment at a temperature lower than that of the primary heat treatment to prepare a positive electrode active material,
wherein the primary heat treatment and the secondary heat treatment are respectively performed in an oxygen atmosphere, and
the secondary heat treatment is performed in the oxygen atmosphere with an oxygen concentration of 50% or more.

5. The method of claim 4, wherein the primary heat treatment is performed at a temperature of 800° C. or more.

6. The method of claim 4, wherein the primary heat treatment is performed in the oxygen atmosphere with an oxygen concentration of 50% or more.

7. The method of claim 4, wherein the primary heat treatment is performed for 10 hours to 20 hours.

8. The method of claim 4, wherein the secondary heat treatment is performed at a temperature of greater than 600° C. to less than 800° C.

9. The method of claim 4, wherein the secondary heat treatment is performed for 2 hours to 12 hours.

10. A positive electrode for a secondary battery, the positive electrode comprising:
a positive electrode collector; and
a positive electrode active material layer formed on the positive electrode collector,
wherein the positive electrode active material layer comprises the positive electrode active material of claim 1.

11. A lithium secondary battery comprising the positive electrode of claim 10; a negative electrode; a separator disposed between the positive electrode and the negative electrode; and an electrolyte.
